(19) United States
(12) Patent Application Publication
(10) Pub. No.: US 2011/0083271 A1
(43) Pub. Date: Apr. 14, 2011

(54) HEAD OF BED ANGLE MOUNTING, CALIBRATION, AND MONITORING SYSTEM

(76) Inventor: Aziz A. Bhai, West Chester, OH (US)

(21) Appl. No.: 12/895,146

(22) Filed: Sep. 30, 2010

Related U.S. Application Data
(60) Provisional application No. 61/250,276, filed on Oct. 9, 2009.

(51) Int. Cl. A61G 7/005; G01P 15/00; G01D 18/00

(52) U.S. Cl. 5/610; 702/141; 702/104

(57) ABSTRACT

A bed includes a frame, a head section coupled to the frame and movable relative to the frame between first and second angular positions, and a sensor operable to determine an angular position of the head section. The sensor is mounted to the head section of the bed at a specified angle. A bed control unit receives signals from the sensor, calibrates the sensor, and monitors the angular position of the head section of the bed relative to gravity.

### CROSS-REFERENCE TO RELATED APPLICATIONS

This application claims the benefit of U.S. Provisional Patent Application No. 61/250,276, filed Oct. 9, 2009, which is incorporated herein by this reference in its entirety.

### TECHNICAL FIELD

This disclosure relates to healthcare beds, such as those used in hospitals and other patient care facilities. More particularly, the present disclosure relates to healthcare beds that have a head section whose angular position can be raised above the horizontal or lowered below the horizontal. This disclosure also relates to an apparatus for mounting an angle sensor to the head section of a healthcare bed. Further, this disclosure relates to computerized systems for calibrating a gravity-based head of bed angle sensor, monitoring the head of bed angle, and issuing an alarm if a specified head of bed angle condition is present.

### BACKGROUND

The TotalCare®, VersaCare®, and CareAssist® beds, made by the Hill-Rom Company, Inc. of Batesville, Ind., are examples of healthcare beds that have articulating deck sections. The head and foot sections of these beds can be automatically raised and lowered by the patient, a caregiver, or another person. U.S. Pat. No. 7,487,562, to Frondorf et al., incorporated herein by this reference, discloses a healthcare bed that includes a head angle alarm system. Aspects of the present disclosure may be used in connection with subject matter disclosed in the '562 patent, and vice versa.

### SUMMARY

The present invention comprises a system, apparatus and/or method that has one or more of the features and/or steps disclosed herein, which alone or in any combination may comprise patentable subject matter.

According to one aspect of this disclosure, a bed includes a base, and a frame coupled to the base. The frame is movable from a Trendelenburg position to a reverse Trendelenburg position. The bed also includes a deck supported by the frame and movable relative to the frame between a horizontal position and an articulated position. The deck includes at least a head section and a foot section spaced from the head section, where the head section is pivotable relative to the frame.

The bed also includes a sensor having a measurement axis operable to determine an angular position of the head section, and a mounting apparatus coupled to the sensor and to the head section. The mounting apparatus orients the measurement axis of the sensor at a non-perpendicular angle relative to the force of gravity.

The sensor may include an accelerometer. The non-perpendicular angle may be in the range of about 65 degrees. The mounting apparatus may include a sensor housing, where the sensor housing is mounted parallel to the head section. The sensor housing may be secured to a longitudinal support member of the head section. The longitudinal support member of the head section may include a side extending perpendicularly to the head section, where the sensor housing is secured to the side. The side of the longitudinal support member may extend downwardly away from the head section. The measurement axis of the sensor may be oriented at an acute angle relative to the head section. The acute angle may be in the range of about 25 degrees.

The bed may include a bed control unit that receives output signals from the accelerometer, calculates a head of bed angle from the output signals, and generates an alarm if the head of bed angle is less than a specified threshold angle. The specified threshold angle may be in the range of about 30 degrees. The bed control unit may use only output signals related to one measurement axis of the accelerometer to calculate the head of bed angle.

According to another aspect of this disclosure, a head of bed angle sensor includes a non-flexible housing having a first side and a second side spaced from the first side, a substrate fixed to the first side of the housing, and an accelerometer mounted to the substrate. The accelerometer has a measurement axis usable to determine an angular position of a pivotable deck section of a bed. The accelerometer is mounted to the substrate to orient the measurement axis at a non-perpendicular angle relative to the force of gravity. The sensor also includes electronics to transmit output signals from the accelerometer to a control unit of the bed.

The accelerometer may be mounted to the substrate with the measurement axis oriented at an angle of about 65 degrees relative to the force of gravity. The head of bed angle sensor may include a mounting arrangement coupled to the second side of the housing, where the mounting arrangement secures the head of bed angle sensor to the pivotable deck section of the bed.

The mounting arrangement may secure the head of bed angle sensor housing to a support member of the pivotable deck section of the bed so that a longitudinal axis of the housing is parallel to a longitudinal axis of the pivotable deck section.

According to a further aspect of this disclosure, a method for calibrating a gravity-based head of bed angle sensor fixedly mounted to a pivotable head section of a bed at an electronic control unit of the bed, includes obtaining first, second, and third electrical output signals from the head of bed angle sensor at first, second, and third calibration points, respectively, where each of the first, second, and third calibration points corresponds to first, second, and third spaced-apart angular positions of the pivotable head section of the bed relative to the force of gravity. The method also includes storing the output signals for the plurality of calibration points in memory coupled to the bed control unit, calculating first, second, and third calibration constants using the first, second, and third output signals, and storing the first, second, and third calibration constants in memory coupled to the bed control unit.

The first calibration constant may be indicative of a mounting offset of the head of bed angle sensor. The second calibration constant may be indicative of a zero-g offset of the head of bed angle sensor. The third calibration constant may be indicative of a sensitivity of the head of bed angle sensor. The first, second, and third calibration points may be in the range of about five, thirty, and fifty degrees, respectively.

The head of bed angle sensor may be mounted to the head section of the bed at a non-perpendicular angle relative to the force of gravity.

According to another aspect of this disclosure, a method for calculating a head of bed angle of a pivotable head section of a bed having a gravity-based sensor fixedly mounted thereto, includes calibrating the sensor according to the method described above, applying a first set of the first, second, and third calibration constants to head of bed angle measurements in a first measurement range, and applying a second set of the first, second, and third calibration constants to head of bed angle measurements in a second measurement range. The first measurement range may be about zero to about thirty degrees. The second measurement range may be about thirty to about fifty degrees.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the following figures, in which:

FIG. 1 is a perspective view of an illustrative healthcare bed with the head section in a raised position;

FIG. 2 is a front perspective view of a user interface for the healthcare bed of FIG. 1;

FIG. 3 is a simplified schematic of a side elevational view of the bed of FIG. 1 showing an angle sensor mounting arrangement;

FIG. 4 is a perspective view of the back side of the head section of the bed of FIG. 1, including an angle sensor mounted thereto;

FIG. 5 is a partial perspective view of the angle sensor mounting area of FIG. 4, showing the position of the angle sensor relative to the head section of the bed;

FIG. 6 is a front elevational view of the angle sensor of FIGS. 4-5;

FIG. 7 is a rear elevational view of the angle sensor of FIG. 6;

FIG. 8 is a block diagram schematically showing elements of the head of bed angle monitoring system of the bed of FIG. 1;

FIG. 9 is a flow chart showing steps performed by the head of bed angle monitoring system of the bed of FIG. 1; and

FIG. 10 is a flow chart showing steps of a calibration method for the head of bed angle monitoring system of FIG. 9.

### DETAILED DESCRIPTION

This disclosure describes a healthcare bed 10 that has an on-board head of bed angle monitoring system. An angle sensor 66 is mounted to the healthcare bed 10 to detect changes in the head of bed angle. Programming logic embodied in computer circuitry installed on the bed 10 calibrates the angle sensor 66 and operates the head of bed angle monitoring system.

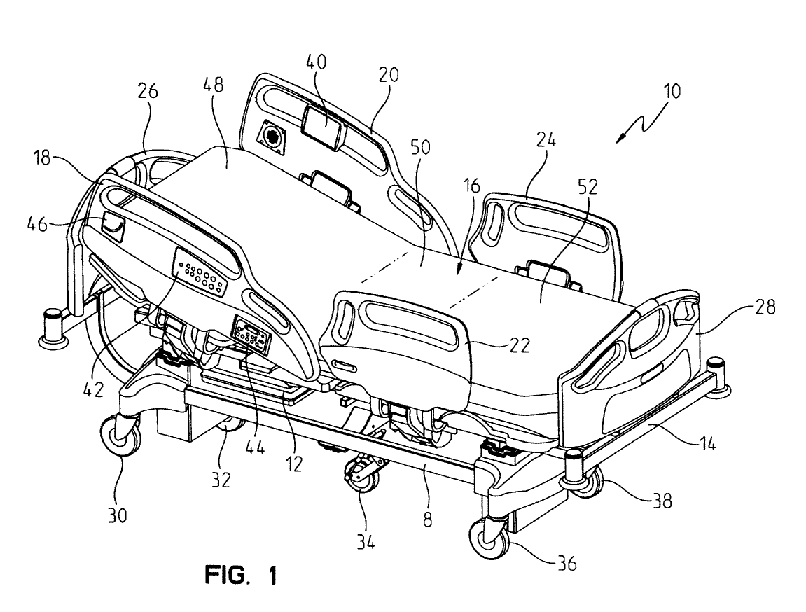

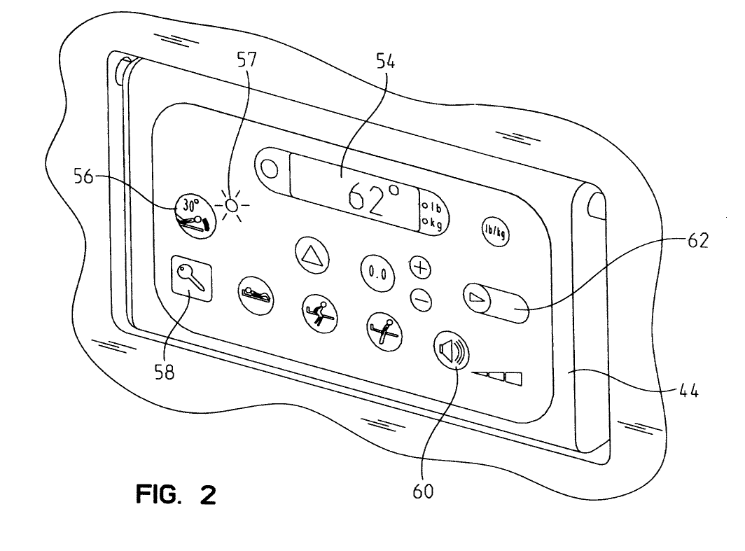

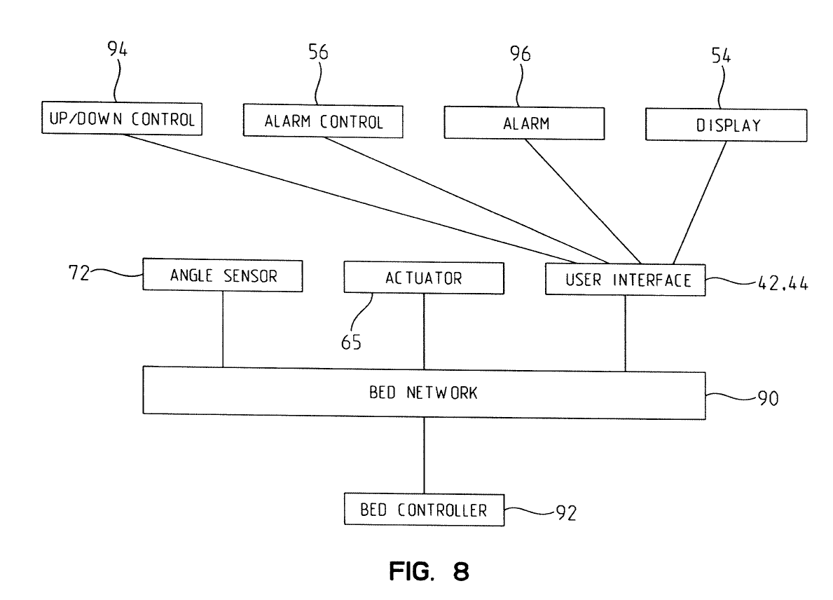

Referring to FIG. 1, the healthcare bed 10 includes a frame 12 coupled to a base 8. The base 8 is movably supported by wheels 30, 32, 34, 36, 38. The frame 12 supports a deck 14. A mattress 16 is supported by the deck 14. Siderails 18, 20, 22, 24 are mounted to opposing sides of the bed 10, while endboards 26, 28 are mounted to opposing ends of the bed 10. The bed 10 supports a patient control module 40 and caregiver control modules 42, 44. The caregiver control module 44 supports the head of bed angle monitoring features described herein. Aspects of the caregiver control module 44 are described below with reference to FIG. 2. The controls panels 42, 44 are in electrical communication with a bed control unit 92, as shown diagrammatically in FIG. 8. The bed 10 also includes a non-digital angular position indicator 46, although this is not required.

The bed 10 includes longitudinally spaced head, seat, and foot sections 48, 50, and 52, respectively. Each of the head, seat and foot sections 48, 50, 52 of the bed has corresponding deck and mattress portions as will be readily understood by those skilled in the art. At least the head and foot sections 48, 52 are pivotable relative to the frame 12. In some embodiments, the seat section 50 may be pivotable relative to the frame 12, as well.

The frame 12 is tiltable between an Trendelenburg (“Trend”) position, in which the head section 48 is lower than the foot section 52, and a reverse Trend position, in which the head section 48 is higher than the foot section 52. When the bed 10 is in the Trend position, the head section 48 is at a negative angle relative to the horizontal. The head of bed angle monitoring system of the bed 10 measures the angle of the head section 48 relative to gravity. The head of bed angle monitoring system accounts for changes in the angular position of the head section 48 relative to the frame 12, as well as changes in the angular position of the frame 12 relative to the horizontal. Aspects of the head of bed angle monitoring computer logic are described below with reference to FIGS. 8-10.

A number of mechanisms may be used to accomplish pivoting of the head section 48 relative to the frame 12. For example, U.S. Pat. No. 5,682,631, which is incorporated herein by this reference, illustrates one example in which a healthcare bed has a head section mounted to a bed frame to pivot using a reduced-shear pivoting technique.

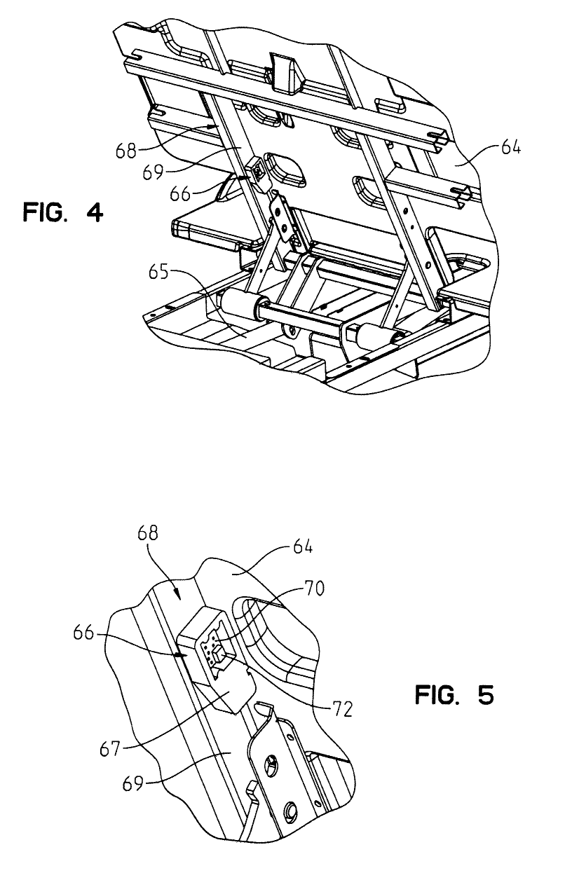

The bed 10 includes several actuators, including a head section actuator 65 shown in FIG. 4. The head section actuator 65 drives articulation of the head section 48. The head section actuator 65 is coupled to a power unit (not shown) mounted on the bed 10. In some embodiments, the head section actuator 65 includes a linear motor (not shown) having a drive shaft. In other embodiments the head section actuator 65 includes a hydraulic cylinder. An example of a healthcare bed having a hydraulic actuator for moving a head section of the bed is disclosed in U.S. Pat. No. 5,715,548, which is hereby incorporated by this reference. An example of a healthcare bed having an electrical linear actuator for moving a head section of the bed is disclosed in U.S. Pat. No. 7,406,731, which is hereby incorporated by this reference.

A lift mechanism 9 is operable to raise, lower, and tilt the frame 12 relative to the base 8. An illustrative lift mechanism for raising, lowering, and tilting a bed is disclosed in the above-mentioned U.S. Pat. No. 5,715,548.

As shown in FIG. 1, caregiver control modules 42, 44 are located on an outboard side of the siderail 18, although this need not be the case. Another set of caregiver control modules 42, 44 may be located on an outboard side of the siderail 20. The caregiver control module 42 includes bed position adjustment controls, such as head up/down controls, leg up/down controls, chair positioning controls, Trendelenburg and reverse Trendelenburg controls, and bed up/down controls.

Referring to FIG. 2, the control module 44 includes a digital head-of-bed angle display 54. The digital angle display is configured according to design requirements of the bed 10. In the illustrated embodiment, the display 54 indicates the current head of bed angle as a positive integer and indicates changes in the head of bed angle in 1-degree increments. When the head of bed angle is within a margin of error of zero degrees, the display 54 displays zero. The digital display 54 may display the head of bed angle whether or not the head of bed angle monitoring system (e.g. the head of bed angle alarm) is activated.

The control module 44 also includes and caregiver controls 56, 58, 60, 62. Control 56 is a head of bed angle alarm control. Control 58 is a lockout control. Control 60 is an alarm volume control. Control 62 is an alerts control.

The head of bed angle alarm control 56 is, in the illustrated embodiment, a toggle switch. When the control 56 is pressed a first time, the head of bed angle monitoring system is activated. An indicator light 57 illuminates when head of bed angle monitoring is active. When the control 56 is pressed a second time, the head of bed angle monitoring system is deactivated and the indicator light 57 turns off. It will be understood that the alarm on/off control 56 may be located on the control module 44 or elsewhere, for example, on a frame member, such as the frame 12, a siderail, a hand-held unit or other structure that is in communication with the bed network 90.

The lockout key 58 is activatable by a caregiver to prevent unauthorized users from activating or deactivating the head of bed monitoring system or other caregiver-controllable bed features. If the head of bed angle alarm control 56 is pressed while the lockout key 58 is activated, the head of bed angle monitoring system will ignore the request to activate the head of bed angle alarm control 56, regardless of the number of times the control 56 is pressed. The head of bed angle monitoring system, and/or other monitoring features of the bed 10, can only be activated if the lockout key 58 is not activated.

The alarm volume key 60 controls the volume level of an audible alarm associated with the head of bed angle monitoring system and/or other monitoring features of the bed 10. Repeatedly activating (e.g. pressing) the control 60 increases or decreases the volume of the alarm.

When the alerts control 62 is activated, an alarm signal or signals generated by the head of bed angle monitoring system and/or other monitoring feature of the bed 10 are communicated electronically to a remote device, such as a dome light of a nurse call system, a computerized display screen of a nurse call system or other healthcare communication system, a speaker located remotely from the bed 10 (in the hallway of a healthcare facility, for example), a portable or handheld device of a caregiver, or other output device that is connected to the bed 10 by a communication network. The alarm signal may take the form of an indicator light, a text message, a graphical icon, an audible sound, or the like. Examples of healthcare communication systems that transmit signals from a bed to a remote device are described in U.S. Pat. Nos. 5,562,412 to Novak et al.; 5,822,544 to Chaco et al.; 5,699,038 to Ulrich et al.; and 7,319,386 to Collins, Jr. et al., each of which is incorporated herein by this reference.

The caregiver control panel 44 may also include controls for other features of the bed 10, such as patient weighing controls and patient position monitoring controls. Aspects of the head of bed angle monitoring system may interface with these or other bed features. For example, the head of bed angle monitoring system may make the head of bed angle information available to the patient weighing system, to be factored into the patient weight calculation. The head of bed angle may be made available to the patient position monitoring system to be considered in determining the patient's position relative to the bed 10. The head of bed angle monitoring system may be active at the same time as these or other monitoring features of the bed, or the head of bed angle monitoring system may be disabled while one or more of these or other monitoring features of the bed are active.

As noted above, the bed 10 is equipped with an angle sensor 66. In general, the angle sensor 66 may be coupled to any suitable portion of the articulating deck section, such as, for example, a frame member, a deck panel, a portion of the mattress, or a siderail that moves along with the articulating deck section.

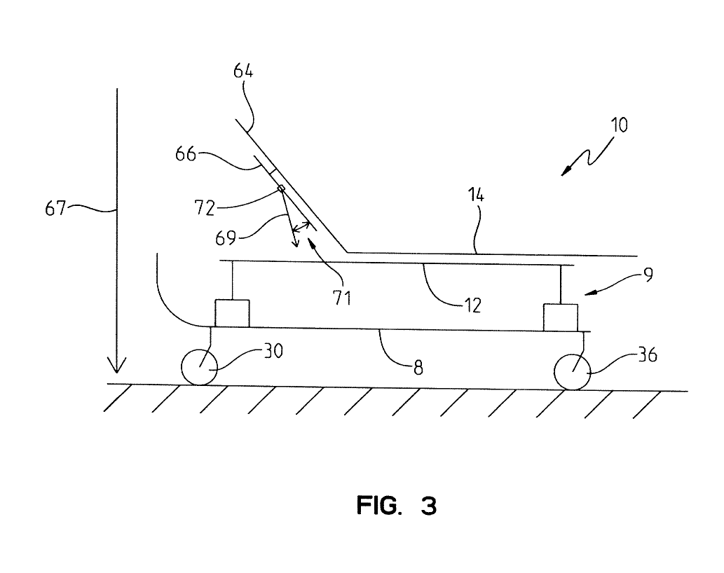

Referring to FIGS. 3-5, in the illustrated embodiment, the angle sensor 66 is mounted to a back side of the articulating head deck section 64 for movement therewith. The head deck section 64 is diagrammatically shown in FIG. 3 as pivoting relative to the frame 12 about a simple pivot axis. However, the angle sensor 66 may be used in connection with head sections having any type of pivot mechanism.

Referring to FIGS. 4-5, the angle sensor 66 is secured to a support member 68 of the head deck section 64 so that the angular position of the angle sensor 66 follows the angular position of the head deck section 64 through the full range of articulation. The support member 68 has a side 69 that is perpendicular to the head deck section 64 and extends downwardly away from the back side of the head deck section 64. In the illustrated embodiment, the angle sensor 66 is mounted to the side 69 of the support member 68 so that it is flush with the corner defined by the intersection of the side 69 with the back side of the head deck section 64. Other mounting arrangements in which the longitudinal axis of the angle sensor 66 is parallel to a longitudinal axis of the head deck section 64 are also possible.

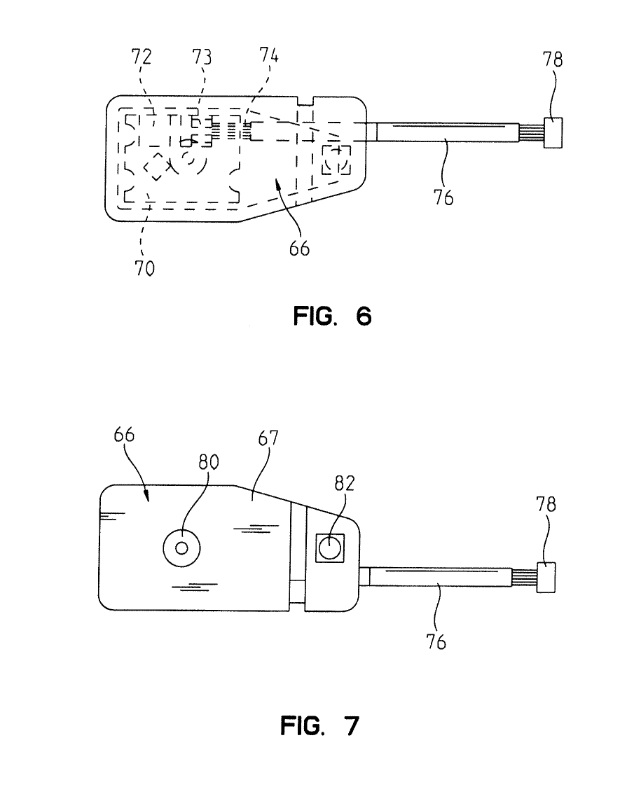

As shown in FIGS. 5-6, the angle sensor 66 includes a housing 67. In the illustrated embodiment, the housing 67 is a pentagonally-shaped PVC overmold, although other housing configurations may be used. An integrated circuit assembly 70 is mounted to one side of the housing 67. The integrated circuit assembly 70 includes a substrate and electrical circuitry mounted to the substrate. An accelerometer 72 is a micromachined sensor mounted to the integrated circuit assembly 70 so that the measurement axis 69 of the accelerometer 72 is oriented at a specified angle relative to gravity as shown in FIG. 3. The specified angle of the measurement axis 69 is determined in accordance with the factors described below with reference to FIG. 3.

The accelerometer 72 is in electrical communication with electronics 73. In the illustrated embodiment, the accelerometer 72 produces an analog output (e.g. voltage). The output of the accelerometer 72 is proportional to acceleration. The accelerometer output is converted to a digital signal by the electronics 73. Electronics 73 include an analog to digital converter and signal processing and/or signal conditioning circuitry as will be appreciated by those skilled in the art. In the illustrated embodiment, electronics 73 includes a low pass filter and a low-offset voltage op-amp configured as a voltage follower to drive the accelerometer output signal. All or a portion of electronics 73 may be located in the bed control unit 92 rather than on the printed circuit assembly 70. Electrical connectors 74, 78 and electrical cable 76 communicate the accelerometer output to the bed control unit 92 via the bed network 90 for use by the head of bed angle monitoring system. In the illustrated embodiment, connectors 74, 78 are CT connectors available from Tyco Electronics Corporation of Berwyn, Pa. Mechanical drawings, wiring schematics, and digital photographs for an embodiment of the angle sensor 66 are included as part of this disclosure at Appendix A of U.S. Provisional Patent Application No. 61/250,276, which is incorporated herein by this reference.

The rear-facing side of the angle sensor housing 67, shown in FIG. 7, includes a mounting apparatus 80, 82. The mounting apparatus 80, 82 is configured to secure the housing 67 to the head deck section 64. In the illustrated embodiment, bolts couple to threaded portions of the apparatus 80, 80 to fix the housing 67 to the frame member 68 of the head deck section 64. Other mounting configurations that orient the measurement axis 69 at the specified angle could also be used.

The angle sensor 66 uses the accelerometer 72 to monitor the head of bed angle. The measurement axis 69 of the accelerometer 72 is arranged such that the accelerometer 72 can measure dynamic acceleration along the measurement axis 69 due to change in velocity over time. The accelerometer 72 also measures static acceleration. The static acceleration measurement represents the orientation of the measurement axis 69 relative to the force of gravity, which is vertical to the true horizon.

In the illustrated embodiment, the accelerometer 72 is a single-axis capacitance-based accelerometer. The ADXL103 single-axis accelerometer, available from Analog Devices of Norwood, Mass., is an example of an angle sensor that is suitable for use in the head of bed angle monitoring system described herein. The Module Design Description for HOB Angle Sensing Using Accelerometer, Document No. NPD09482, which is incorporated herein by this reference and included as part of this disclosure at Appendix B of U.S. Provisional Patent Application No. 61/250,276, further describes the operation of a single-axis capacitance-based accelerometer at pages 4-6 thereof. A dual-axis accelerometer may also be used, however, in that case, the output of only one of the two measurement axes (e.g., the ‘Y’ axis) would be used by the head of bed angle monitoring system of bed 10.

Referring back to FIG. 3, the angle sensor 66 is mounted to the head frame 64 so that the measurement axis 69 is oriented at an angle 71 relative to the longitudinal axis of the head deck section 64. The measurement axis 69 is thereby oriented relative to the direction of gravity 67 at an angle of 90 degrees minus the value of angle 71.

The value of the measurement axis angle 71 is determined based on factors related to the operation of the bed 10, the head of bed angle monitoring system, and the specifications of the angle sensor 66. The bed 10 has a maximum range of angular positions for the head frame 64, relative to the horizontal. Since the bed 10 is designed to assume a Trendelenburg (“Trend”) position in which the head frame 64 is below the horizontal, the range of angular positions includes negative values. In the illustrated embodiment, the desired range of angular positions of the head frame 64 is −18 degrees (the full Trend position) to +88 degrees (the maximum inclination of the head frame 64, with head frame 64 fully raised and the bed 10 in full reverse Trend position) relative to the horizontal.

As the head deck section 64 is moved from the full Trend position to the full head-up reverse Trend position (i.e., over the full range of angular positions), the measurement axis 69 experiences sufficient changes in gravitational force to resolve the head of bed angle degree changes over the full range within the specified margin of error. The desired change in gravitational force is provided if, taking the sine of the desired measurement angle (in degrees), the slope of the sine curve is sufficiently greater than zero at all values in the desired range of angular measurement. A graph depicting the sine curve used in the illustrated embodiment is shown on page 7 of Appendix A of U.S. Provisional Patent Application No. 61/250,276.

The angle 71 of the measurement axis 69 is also selected to minimize the effect of disturbance forces on the gravitational force measured by the accelerometer 72. Such disturbance forces may occur due to movements of the patient on the bed 10. This concept is illustrated at page 7 of Appendix A of U.S. Provisional Patent Application No. 61/250,276.

The angle 71 is also selected so that the maximum voltage output of the accelerometer 72 remains less than a specified voltage limit, such as the reference voltage of the analog to digital converter of electronics 73. In the illustrated embodiment, the specified maximum voltage output of the accelerometer 72 is less than 2.5 volts through the full range of angular measurement.

The angle 71 is also selected in accordance with the temperature characteristics of the accelerometer 72. Extreme temperature exposures can potentially cause hysteresis offset at the output of the accelerometer. Temperature exposures may occur, for example, during transportation of the bed 10 from one location to another. The angle 71 is selected to minimize hysteresis offsets due to temperature. The angle 71 is also selected to enable calibration of the accelerometer 72 over a desired temperature range. In the illustrated embodiment, the desired temperature range is between about 10 and about 40 degrees Celsius.

In view of the foregoing considerations and others, which are described in Appendix A of U.S. Provisional Patent Application No. 61/250,276, the measurement axis 69 of the angle sensor 66 is oriented at an angle in the range of about 65 degrees relative to the direction of gravity 67. To achieve the desired mounting orientation of the measurement axis 69 relative to gravity, the angle sensor 66 is mounted to the head frame 64 so that the longitudinal axis of the angle sensor 66 is parallel to the longitudinal axis of the head frame 64 as discussed above. Thus, when the angle sensor 66 is mounted to the head frame 64, the angle 71 of the measurement axis 69 is in the range of about 25 degrees relative to the longitudinal axis of the head frame 64.

The accelerometer tilt data spread sheet, which is incorporated herein by this reference and included as part of this disclosure at Appendix C of U.S. Provisional Patent Application No. 61/250,276, provides data relating to the determination of the specified angle 71.

Referring to FIGS. 8-10, aspects of the head of bed angle monitoring system of the bed 10 will now be described. In operation, the bed control unit 92 communicates with the devices 42, 44, 54, 56, 65, 72, 94 over the bed network 90. In the illustrated embodiment, the bed network 90 is a controller area network (CAN), however, other types of networks may be used as will be understood by those skilled in the art. Illustrative computer networks for a bed are disclosed in U.S. Pat. Nos. 6,279,183 to Kummer et al. and 7,319,386 to Dixon et al., both of which are incorporated herein by this reference.

The controller 92 monitors the operation of the up/down control 94 and the actuator 65 and, if the head of bed angle monitoring system is activated (i.e. the alarm control 56 is turned on), the controller 92 activates the alarm 96 if the head of bed angle is less than a specified angle.

The specified angle that triggers an alarm condition is referred to herein as the threshold angle. In the illustrated embodiment, the threshold angle is fixed. Further, in the illustrated embodiment, the threshold angle is in the range of about 30 degrees above horizontal plus or minus the acceptable margin of error. In some embodiments, however, the threshold angle may be a range of values or multiple values (a minimum and a maximum, for example). Also, in some embodiments, the threshold angle may be selectable as described in U.S. Pat. No. 7,487,562, for example. The threshold angle is stored in a memory, such as a flash memory, associated with the controller 92.

The bed control unit 92 includes one or more modules. The module or modules of the bed control unit 92 typically include a printed circuit assembly, which may include one or more microcontrollers or microprocessors. Some of the modules may be located on various parts of the bed 10 while others are centrally located. For example, a main module may be installed on the base 8. The modules are configured to execute computer logic stored in associated memories to perform steps or processes that are defined by computer programming (e.g firmware or software).

Computer logic executable by the controller 92 is configured to compare data corresponding to the head section angular position, as determined by data from the angle sensor 72, to the threshold angle and activate the alarm 96 if the data corresponding to the head section angular position is less than the threshold angle. In other embodiments, and at the option of the system designer and software programmer, the logic condition to be satisfied for activating the alarm may be a greater than, a greater than or equal to, or a less than condition, in lieu of the less than or equal to logic condition of the illustrative embodiment.

If the caregiver has not activated the head of bed angle alarm control 56, the controller 92 continues to monitor the head alarm on/off control 56. Those skilled in the art will appreciate that the controller 92 may perform other tasks and therefore, the monitoring of the control 56 system may not be continuous, but rather may occur from time-to-time.

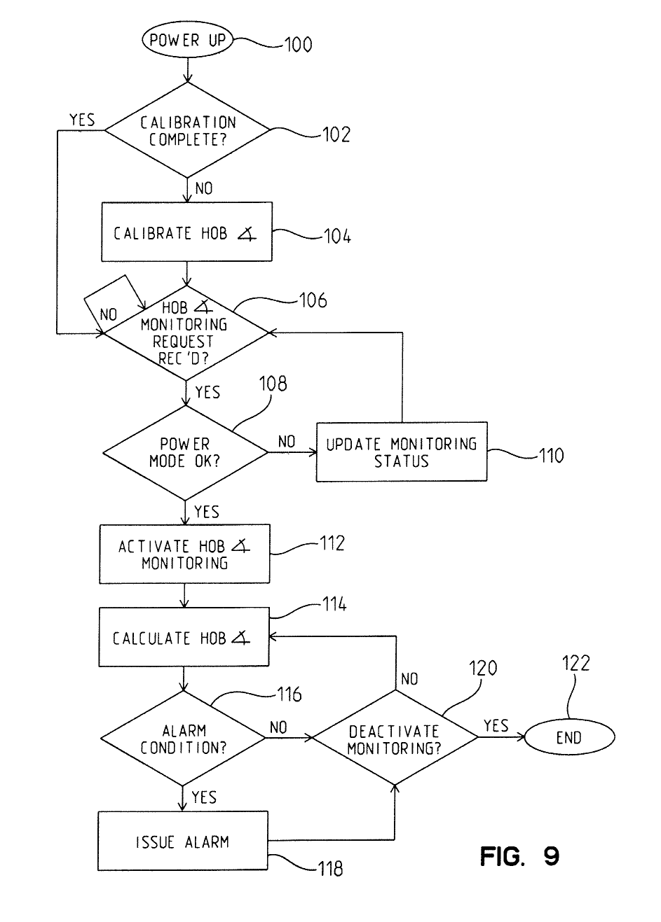

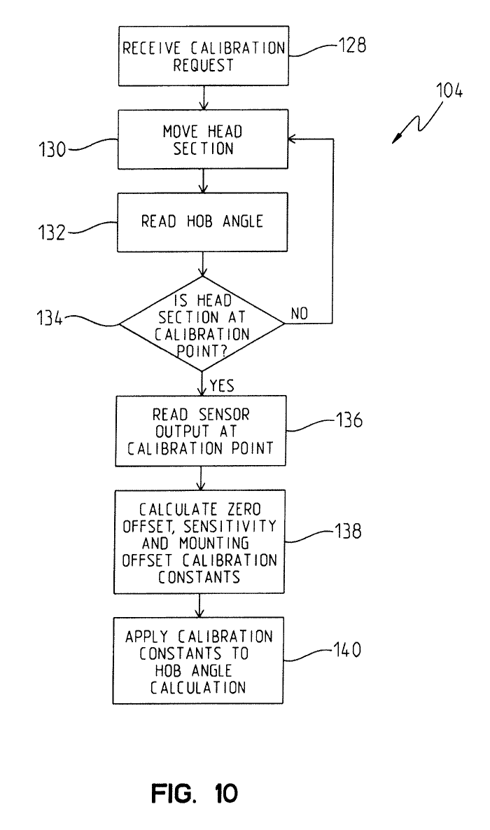

FIGS. 9-10 illustrate steps or processes of the head of bed angle monitoring system that are executable by the controller 92. When the angle sensor 66 has been mounted to the bed 66 as described above, and AC power (i.e. non-battery power) to the bed 10 is turned on (step 100), the controller 92 determines whether the angle sensor 66 has been calibrated (step 102). If the angle sensor calibration has been completed, then the controller 92 checks to see if a head of bed angle monitoring request has been received (step 106, described below).

If the angle sensor calibration has not been completed, then the controller 92 executes a routine or routines to calibrate the angle sensor 66 (step 104). The calibration routine(s) are configured for a single axis (or single output) accelerometer mounted to the bed 10 with the measurement axis at the specified angle 71. The calibration step 104 is defined further in FIG. 10, described below.

Once the angle sensor calibration has been completed, the controller 92 checks to see if a head of bed angle monitoring request has been received (step 106). If no such request is detected, the system waits for such a request. As will be readily understood by those skilled in the art, the controller 92 can perform other functions while waiting for a head of bed angle monitoring request. In the illustrated embodiment, a head of bed angle monitoring request is an electrical signal issued by the alarm control 56 in response to activation of the control 56 by a caregiver. In other embodiments, requests to activate or deactivate head of bed angle monitoring may be initiated by a signal from an electronic device, a computer, a computerized process, or even a remote device. For example, the controller 92 may be configured to turn on head of bed angle monitoring as soon as the patient position monitoring system detects the presence of a patient on the bed 10, or as soon as the head of bed angle of the bed 10 exceeds the threshold angle. As another example, a caregiver may be able to activate or deactivate head of bed angle monitoring from a remote computer, such as a nurse's station or handheld device, which communicates with the bed 10 through a healthcare communication system.

If a head of bed angle monitoring request has been received, the system checks the bed's power mode (step 108). If AC power to the bed 10 is lost, or for some other reason the bed 10 is operating on battery power, the head of bed angle monitoring system is either not turned on or turned off if previously on. The system updates the monitoring status (e.g. to “off” or “disabled”), reports the updated monitoring status to the controller 92 (step 110), and waits for another head of bed angle monitoring request (step 106).

If the bed 10 is operating on non-battery power, then the head of bed angle monitoring system is activated (step 112). The angle sensor 66 is turned on, the monitoring status is updated (e.g. to “on or “enabled”) and monitoring of the head of bed angle begins.

During head of bed angle monitoring, the system reads the accelerometer output and calculates the head of bed angle in a continuous manner as long as the bed 10 is running on AC power and a request to deactivate head of bed angle monitoring has not been received (step 114). In other embodiments, the head of bed angle may be calculated at specified time intervals.

In calculating the head of bed angle, the system applies the calibration constants that are determined during calibration of the angle sensor 66 (step 104). Also, hysteresis and debounce time are factored in to the head of bed angle calculation to determine whether an alarm condition actually exists (step 116). In this way, the system accounts for the possibility that a head of bed angle reading below the threshold angle may be due to normal patient movement (which may flex the head deck section 64) or to a caregiver placing the bed 10 into a CPR position (e.g. in response to the patient experiencing an urgent healthcare event). If the calculated head of bed angle is not a whole number, the calculated value is rounded to generate the integer value that will be displayed on display 54.

If the system determines that an alarm condition is present (step 116), then an alarm is issued (step 118). The alarm may be an audible or visual signal, and may be presented locally at the bed 10 or at a remote location, as discussed above.

If an alarm condition is not present, or the alarm has been issued, then the system checks to see if the head of bed angle monitoring system should be deactivated (step 120). The head of bed angle monitoring system is deactivated if a “deactivate” signal is received from the control 56, if the bed's power mode switches to battery, if the head of bed angle exceeds the threshold angle, after an elapse of time, or the occurrence of some other triggering event. If a deactivate signal or condition is detected, then the head of bed angle monitoring system is turned off (step 122). If no such signal or condition is detected, then head of bed angle monitoring continues (step 114).

Aspects of the above-described steps and processes are also described at pages 54-59 of the Siderail Interface (SRI) Module Software Design Description, Document No. NPD09483, which is incorporated herein by this reference and is included in this disclosure at Appendix D of U.S. Provisional Patent Application No. 61/250,276.

Referring to FIG. 10, aspects of a three-point calibration process for the angle sensor 66 are shown. The calibration process is performed upon start up of the bed, after the angle sensor is installed with the measurement axis 69 oriented at the specified angle 71 as described above. Typically, the calibration is performed during manufacturing of the bed 10 or upon initiation by a technician (e.g. during a service call) and need not be repeated each time the bed 10 is turned on. However, the calibration may be performed each time system power is reset or the system transitions from battery to AC power, or upon the occurrence of some other triggering event.

The calibration process is initiated by the receipt of a calibration request (step 128). The calibration request is typically embodied in an electrical signal. For example, if the calibration process was not previously completed successfully for the bed 10, the system will detect a “not calibrated” state. The calibration request may also be initiated by user input, e.g. a technician pressing a button on a service screen of the bed 10.

After a calibration request is received, the system proceeds to obtain the data points needed for the calibration. The illustrated embodiment uses three calibration points. Each calibration point corresponds to a specified head of bed angle. For example, the calibration points may be zero, 30 and 60 degrees. In the illustrated embodiment, the calibration points are in the range of about 5, 30 and 50 degrees.

The head deck section 64 of the bed 10 is moved to the first calibration point (step 130). The head deck section 64 may be moved by user operation of the head up/down control 94, or by the automatic issuance of a step request by the controller 92 to operate the actuator 65. When the angular position of the head deck section 64 arrives at the first calibration point (e.g. 5 degrees elevation), the system captures the digitized output of the angle sensor 66 (i.e. the ADC count) and stores it in memory (steps 132, 134, 136). The system repeats steps 130, 132, 134, 136 until all of the calibration points are obtained. In the illustrated embodiment, steps 130, 132, 134, 136 are repeated for the second calibration point (e.g. 30 degrees) and the third calibration point (e.g. 50 degrees).

Once the calibration points are obtained, the system calculates three calibration constants (step 138). The three calibration constants are the mounting offset, the zero-g offset, and the sensitivity. The mounting offset is the actual angle of the measurement axis 69 to the direction of the line of force of gravity. While it is anticipated that the accelerometer 72 will be mounted so that the angle 71 of the measurement axis equals the specified angle (e.g. 65 degrees to the vertical axis/25 degrees to the head of deck section 64), some mounting error may occur. The mounting offset therefore indicates the amount of mounting error. The mounting offset, F, is calculated using the equation A below.

Once the mounting offset F is calculated, then the zero-g offset and the sensitivity are calculated. Each of these calibration constants is calibrated using (1) the data points collected at the zero and 30 degree head of bed angle orientations, and (2) the data points collected at the 30 and 50 degree head of bed angle orientations. Thus, two different sets of zero-g offset (“A_{c}”) and sensitivity (“A_{d}”) calibration constants are calculated. The first set of A_{c} and A_{d} calibration constants (i.e. those generated using the zero and thirty degree orientations) are used in the head of bed angle calculation (step 114 of FIG. 9) for angles in the zero to thirty degree range. The second set of A_{c} and A_{d} calibration constants (i.e. those generated using the thirty and fifty degree orientations) are used in the head of bed angle calculation (step 114 of FIG. 9) for angles in the thirty to sixty degree range. The sensitivity A_{d} is calculated using the equation B below. The zero-g offset A_{c} is calculated using the equation C below.

$$\begin{matrix}F = {Tan}^{- 1} ( \frac{{K}_{6} {K}_{1} - {K}_{5} {K}_{3}}{{K}_{6} {K}_{2} - {K}_{5} {K}_{4}} ) & Equation A \\ {A}_{d} = \frac{{K}_{5}}{{K}_{1} Cos ( F ) - {K}_{2} Sin ( F )} & Equation B \\ {A}_{c} = {a}_{y} - {A}_{d} * Cos ( F + y ) & Equation C\end{matrix}$$

### Where,

K₁=Cos(x)−Cos(y); K₂=Sin(x)−Sin(y)

K₃=Cos(z)−Cos(x); K₄=Sin(z)−Sin(x)

K₅=aₓ−a_{y}; K₆=a_{z}−aₓ

aₓ: is the accelerometer output ADC count at HOB angle x

a_{y}: is the accelerometer output ADC count at HOB angle y

a_{z}: is the accelerometer output ADC count at HOB angle z

The calibration constants are determined in view of the acceptable margin of error for the head of bed angle reading. The margin of error may be defined differently for different angular positions. For example, the acceptable margin of error may be smaller around the zero, 30, and 50 or 60 degree angular positions than for other angular positions in the measurement range.

Once the calibration constants are determined, they are stored in memory for use in the head of bed angle calculation (step 114 of FIG. 9) of the head of bed angle monitoring system (step 140 of FIG. 10).

Aspects of the above-described calibration method are also shown and described at pages 10-14 of Appendix A of U.S. Provisional Patent Application No. 61/250,276 and at page 55 of Appendix D of U.S. Provisional Patent Application No. 61/250,276.

Although certain illustrative embodiments have been described in detail above, variations and modifications exist within the scope and spirit of this disclosure as described and as defined in the following claims. For example, while an angle sensor, mounting configuration, and angular position monitoring system are described herein in the context of a head of bed angle monitoring application, these features and/or aspects thereof are applicable to other articulating sections of a healthcare bed, such as a seat, leg, or foot section, should it be desirable to monitor the angular position of any of these other sections of the bed.

1. A bed comprising
a base,
a frame coupled to the base, the frame being movable from a Trendelenburg position to a reverse Trendelenburg position,
a deck supported by the frame and movable relative to the frame between a horizontal position and an articulated position, the deck comprising at least a head section and a foot section spaced from the head section, the head section being pivotable relative to the frame,
a sensor having a measurement axis operable to determine an angular position of the head section, and
a mounting apparatus coupled to the sensor and to the head section, the mounting apparatus configured to orient the measurement axis of the sensor at a non-perpendicular angle relative to the force of gravity.

2. The bed of claim 1, wherein the sensor comprises an accelerometer.

3. The bed of claim 2, wherein the non-perpendicular angle is in the range of about 65 degrees.

4. The bed of claim 3, wherein the mounting apparatus comprises a sensor housing, and the sensor housing is mounted parallel to the head section.

5. The bed of claim 4, wherein the sensor housing is secured to a longitudinal support member of the head section.

6. The bed of claim 5, wherein the longitudinal support member of the head section comprises a side extending perpendicularly to the head section, and the sensor housing is secured to the side.

7. The bed of claim 6, wherein the side of the longitudinal support member extends downwardly away from the head section.

8. The bed of claim 2, wherein the measurement axis of the sensor is oriented at an acute angle relative to the head section.

9. The bed of claim 8, wherein the acute angle is in the range of about 25 degrees.

10. The bed of claim 3, comprising a bed control unit configured to receive output signals from the accelerometer, calculate a head of bed angle from the output signals, and generate an alarm if the head of bed angle is less than a specified threshold angle.

11. The bed of claim 10, wherein the specified threshold angle is in the range of about 30 degrees.

12. The bed of claim 11, wherein the bed control unit only uses output signals related to one measurement axis of the accelerometer to calculate the head of bed angle.

13. A head of bed angle sensor comprising
a non-flexible housing having a first side and a second side spaced from the first side,
a substrate fixed to the first side of the housing,
an accelerometer mounted to the substrate, the accelerometer having a measurement axis usable to determine an angular position of a pivotable deck section of a bed, the accelerometer being mounted to the substrate to orient the measurement axis at a non-perpendicular angle relative to the force of gravity, and
electronics to transmit output signals from the accelerometer to a control unit of the bed.

14. The head of bed angle sensor of claim 12, wherein the accelerometer is mounted to the substrate with the measurement axis oriented at an angle of about 65 degrees relative to the force of gravity.

15. The head of bed angle sensor of claim 14, comprising a mounting arrangement coupled to the second side of the housing, wherein the mounting arrangement is configured to secure the head of bed angle sensor to the pivotable deck section of the bed.

16. The head of bed angle sensor of claim 15, wherein the mounting arrangement secures the head of bed angle sensor housing to a support member of the pivotable deck section of the bed so that a longitudinal axis of the housing is parallel to a longitudinal axis of the pivotable deck section.

17. A method for calibrating a gravity-based head of bed angle sensor fixedly mounted to a pivotable head section of a bed at an electronic control unit of the bed, the method comprising
obtaining first, second, and third electrical output signals from the head of bed angle sensor at first, second, and third calibration points, respectively, each of the first, second, and third calibration points corresponding to first, second, and third spaced-apart angular positions of the pivotable head section of the bed relative to the force of gravity,
storing the output signals for the plurality of calibration points in memory coupled to the bed control unit,
calculating first, second, and third calibration constants using the first, second, and third output signals, and
storing the first, second, and third calibration constants in memory coupled to the bed control unit.

17. The method of claim 17, wherein the first calibration constant is indicative of a mounting offset of the head of bed angle sensor, the second calibration constant is indicative of a zero-g offset of the head of bed angle sensor, and the third calibration constant is indicative of a sensitivity of the head of bed angle sensor.

18. The method of claim 17, wherein the first, second, and third calibration points are in the range of about five, thirty, and fifty degrees, respectively.

19. The method of claim 18, wherein the head of bed angle sensor is mounted to the head section of the bed at a non-perpendicular angle relative to the force of gravity.

20. A method for calculating a head of bed angle of a pivotable head section of a bed having a gravity-based sensor fixedly mounted thereto, comprising
calibrating the sensor according to the method of claim 19,
applying a first set of the first, second, and third calibration constants to head of bed angle measurements in a first measurement range, and
applying a second set of the first, second, and third calibration constants to head of bed angle measurements in a second measurement range.

21. The method of claim 20, wherein the first measurement range is about zero to about thirty degrees, and the second measurement range is about thirty to about fifty degrees.
